(19) United States
(12) Patent Application Publication
(10) Pub. No.: US 2010/0153746 A1
(43) Pub. Date: Jun. 17, 2010

(54) MEMORY CONTROLLER, SECURE MEMORY CARD, AND SECURE MEMORY CARD SYSTEM

(75) Inventors: Yasuo Takeuchi, Tokyo (JP); Yoshihiko Takagi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/088,591

(22) PCT Filed: Aug. 7, 2007
(86) PCT No.: PCT/JP2007/065443

§ 371 Date: Mar. 28, 2008

(30) Foreign Application Priority Data
Aug. 10, 2006 (JP) 2006-218795

(51) Int. Cl. G06F 12/14

(52) U.S. Cl. 713/193

(57) ABSTRACT

The present patent application is for solving a problem of occurrence of efforts required to replace a signature and consumption of time induced by the efforts.

A secure memory card of the present patent application has a communication unit receiving encryption data and data to be signed; an encryption/decryption unit subjecting arbitrary data to encryption/decryption processing; a checking unit for checking the data to be signed against a signature stored in the encryption data decrypted by the encryption/decryption unit; a determination unit for determining validity of the data to be signed on the basis of a checking result of the checking unit; and a storage unit for storing, as valid data, data other than the signature of the encryption data including the signature when the determination unit determines that the data to be signed are valid.

### TECHNICAL FIELD

The present invention relates to a memory controller for controlling nonvolatile memory, a secure memory card having nonvolatile memory such as a semiconductor memory card, and a secure memory card system having the secure memory card and an access device.

### BACKGROUND ART

A technique for safely distributing and selling contents to users by means of one server distributing encrypted data and another server distributing a key used at the time of decryption of the encrypted data is available as a related-art technique (Patent Document 1). The encrypted data distributed to the user includes a plurality of encryption information parts, a list of the encryption information parts, and a signature for the list.

Patent Document 1: Japanese Patent No. 3130267

### DISCLOSURE OF THE INVENTION

### Problem that the Invention is to Solve

However, according to the related-art technique, the signature must be reaffixed to the list every time specifics of the list are changed. Specifically, every time part of encrypted data is changed, specifics of a list are changed, and hence a signature must be reaffixed to the list. Accordingly, reaffixing of a signature has required consumption of much time and efforts.

Therefore, the present invention provides a memory controller and a secure memory card that adopt a data structure for collectively encrypting data to serve as a target to be signed, a signature, and another set of data which is not an object of the signature, thereby obviating a necessity for reaffixing a signature even when a change is made to part of the data that are not an object of the signature.

### Means for Solving the Problem

A memory controller of the present invention has a communication unit receiving encryption data and data to be signed; an encryption/decryption unit subjecting data to encryption/decryption processing; a checking unit checking the data to be signed against a signature stored in the encryption data decrypted by the encryption/decryption unit; a determination unit determining validity of the data to be signed on the basis of a checking result of the checking means; and a storage unit for storing, as valid data, data other than the signature of the encryption data including the signature when the determination means determines that the data to be signed are valid.

A secure memory card of the present invention has nonvolatile memory, the memory controller reading or writing data from and to the nonvolatile memory, and an encryption/decryption unit. The secure memory card has a communication unit for receiving encryption data and data to be signed; an encryption/decryption unit subjecting data to encryption/decryption processing; a checking unit checking the data to be signed against a signature stored in the encryption data decrypted by the encryption/decryption unit; a determination unit determining validity of the data to be signed on the basis of a checking result of the checking unit; and a storage unit for storing, as valid data, remaining data of the encryption data including the signature when the determination unit determines that the data to be signed are valid.

A secure memory card system of the present invention is made up of a secure memory card and an access device. The secure memory card has a communication unit for receiving encryption data and data to be signed; an encryption/decryption unit subjecting data to encryption/decryption processing; a checking unit checking the data to be signed against a signature stored in the encryption data decrypted by the encryption/decryption unit; a determination unit for determining validity of the data to be signed on the basis of a checking result of the checking unit; and a storage unit for storing, as valid data, data other than the signature of the encryption data including the signature when the determination unit determines that the data to be signed are valid. The access device has a communications unit establishing communication with the secure memory card; a storage unit storing data to be transmitted to the secure memory card; and a protocol conversion unit that reads from the storage means data to be transmitted to the secure memory card and that converts the data into data which can be received by the secure memory card, wherein a result notified by the secure memory card is received, and communication with the secure memory card is controlled on the basis of the result.

### ADVANTAGE OF THE INVENTION

There is adopted a data structure in which data to be signed, a signature, and other data which are not targets to be signed are encrypted along with each other. As a result, when a signature can be verified correctly, the validity of the other data encrypted along with the signature also becomes reliable. Hence, there is obviated a necessity for replacing a signature every time a change is made to part of data which are not objects to be signed.

### BRIEF DESCRIPTION OF THE DRAWINGS

FIG. 1 is a relational view of a server, an external device, and a card;

FIG. 2 is a block diagram of the card;

FIG. 3 is a block diagram of the server, that of the external device, and that of the card;

FIG. 4 is a relational view of a player;

FIG. 5 is the flow of processing performed among an application developer, a service provider, the manufacturer of the card, and the card;

FIG. 6 is the flow of processing performed between a server operator and the service provider;

FIG. 7-a is a flow “a” of processing performed among the server operator, the server, the external device, and the card;

FIG. 7-b is a flow “b” of processing performed among the server operator, the server, the external device, and the card;

FIG. 7-c is a flow “c” of processing performed among the server operator, the server, the external device, and the card;

FIG. 8 is a view showing an example of individual initial data;

FIG. 9 is a view showing an example management data format;

FIG. 10 is a relational view between a data storage configuration of the server and card version information;

FIG. 11 is a block diagram of the card including area control unit;

FIG. 12 is a flow of communication performed between the card and the external device;

FIG. 13 is a flow of communication performed between a card having two communications channels and the external device;

FIG. 14 is a flow of communication performed at the time of update of data;

FIG. 15-a is a flow “a” of processing performed at the time of update of data;

FIG. 15-b is a flow “b” of processing performed at the time of update of data;

FIG. 16-a is a flow “a” of processing performed together with a card having two channels and the external devices;

FIG. 16-b is a flow “b” of processing performed together with the card having two channels and the external devices; and

FIG. 16-c is a flow “c” of processing performed together with the card holding two channels and the external devices.

### DESCRIPTIONS OF THE REFERENCE NUMERALS

100 CARD
1001 COMMUNICATIONS UNIT
1002 COMMAND INTERPRETATION UNIT
1003 DETERMINATION UNIT
1004 NUMERICAL COMPUTATION UNIT
1005 STORAGE UNIT
1006 ENCRYPTION/DECRYPTION UNIT
1007 CHECKING UNIT
1008 DETERMINATION UNIT
1009 HASH GENERATION UNIT
1010 AREA CONTROL UNIT
200 EXTERNAL DEVICE
2001 COMMUNICATION UNIT
2002 PROTOCOL CONVERSION UNIT
2003 TEMPORARY STORAGE UNIT
300 SERVER
3001 COMMUNICATIONS UNIT
3002 STORAGE CONTROL UNIT
3003 STORAGE MEANS
P1 CARD MANUFACTURER
P2 APPLICATION DEVELOPER
P3 SERVICE PROVIDER
P4 SERVER OPERATOR
P5 USER
P6 CARD SELLER
M01 MANUFACTURER PUBLIC KEY
M02 MANUFACTURER SECRET KEY
M03 CARD PUBLIC KEY
M04 CARD SECRET KEY
A01 APPLICATION CODE ENCRYPTION KEY
A02 APPLICATION CODE
A03 ENCRYPTED APPLICATION CODE
A04 ENCRYPTED APPLICATION CODE ENCRYPTION KEY
A05 SIGNATURE
H01 INDIVIDUAL INITIAL DATA ENCRYPTION KEY
H02 INDIVIDUAL INITIAL DATA
H03 ENCRYPTED INDIVIDUAL INITIAL DATA
H04 ENCRYPTED INDIVIDUAL INITIAL DATA ENCRYPTION KEY
H05 HASH GENERATED BY INDIVIDUAL INITIAL DATA
H06 COMMON DATA
H07 MANAGEMENT DATA
H08 MANAGEMENT DATA ENCRYPTION KEY
H09 ENCRYPTED MANAGEMENT DATA
H10 ENCRYPTION KEY OF ENCRYPTED MANAGEMENT DATA

### BEST MODES FOR IMPLEMENTING THE INVENTION

Embodiments of the present invention will be described hereunder by reference to the drawings. However, the present invention is not limited to the embodiments and can be carried out in various forms within the scope of the gist of the invention.

### First Embodiment

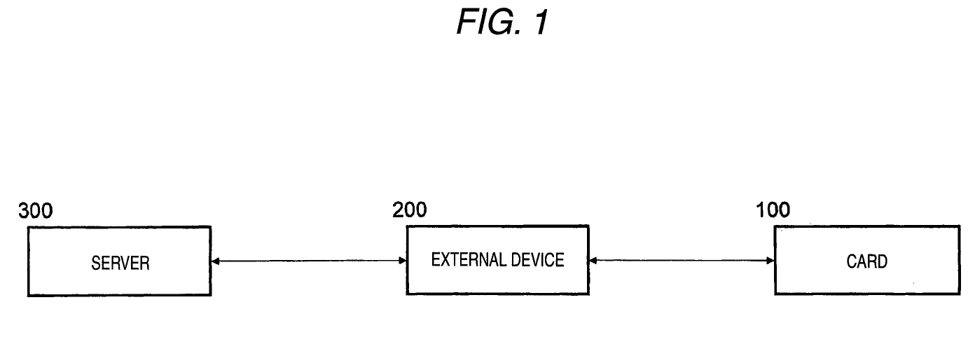

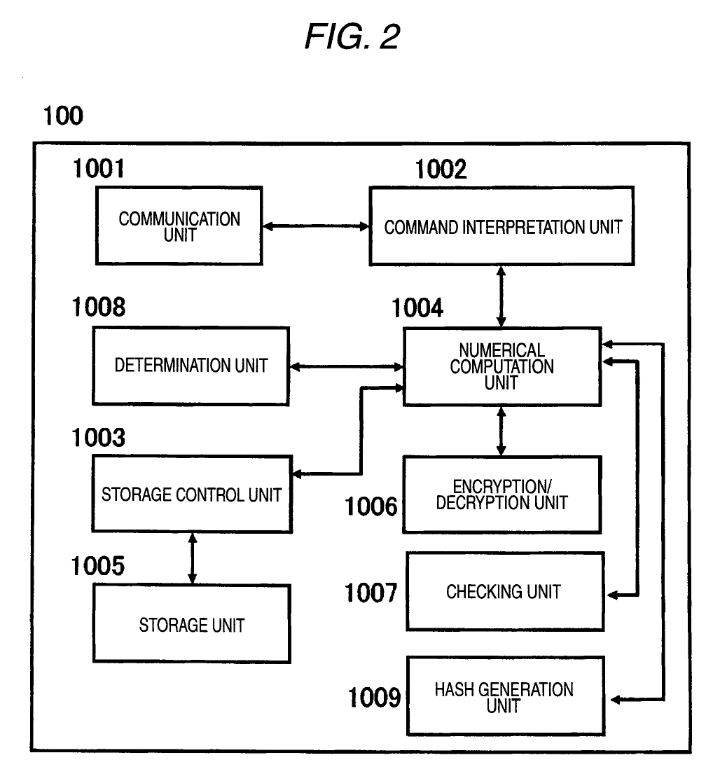

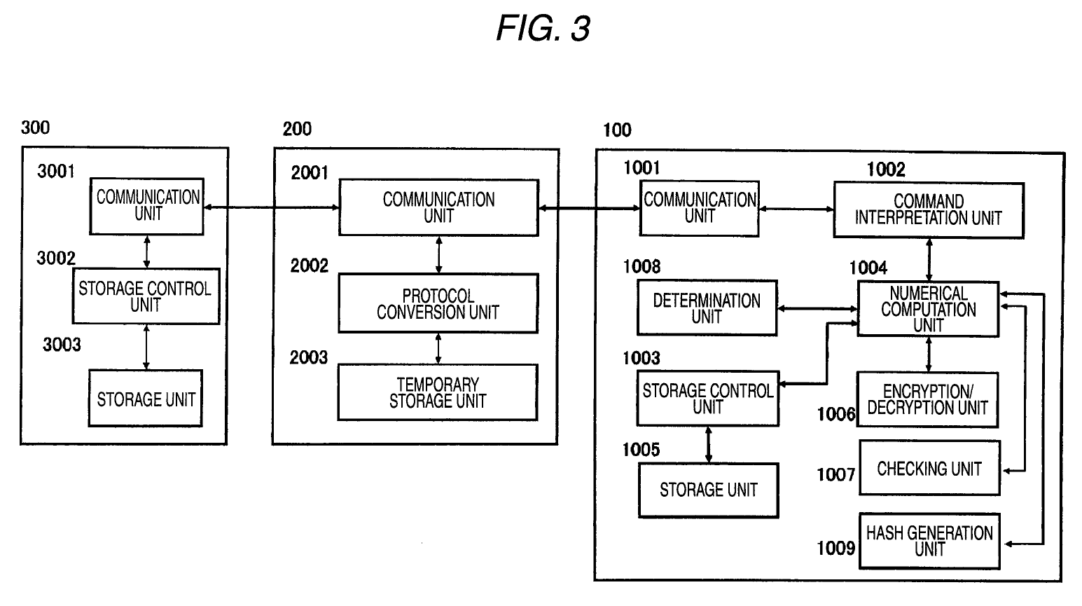

In the present embodiment, a secure memory card system built from a server (300), an external device (200), and a card (100), such as those shown in FIG. 1, will be described. FIG. 2 shows the configuration of the card (100). FIG. 3 shows the detailed configuration of the secure memory card system shown in FIG. 1. Descriptions are provided below by reference to FIG. 3.

The server (300) has a communication unit (3001) that establishes communication with the outside; a storage control unit (3002); and a storage unit (3003). The storage unit (3003) holds application data, application codes, corresponding card information, and information about other external terminals. An application is made by combination of an application code and application data. The application code refers to an object such as a practicable program or code. The application data refer to data to which the code makes a reference and are prepared for the purpose of controlling the operation or behavior of the application or imparting initial setting values to the application. In the present embodiment, an application and application data are described to be separated from each other, but the application data may also be included as part of the application code.

The storage control unit (3002) can selectively read data from the storage unit (3003), upon receipt of a request from the outside by way of the communication unit (3001), in accordance with a request from the request.

The external device (200) has a communication unit (2001), a protocol conversion unit (2002), and a temporary storage unit (2003). The communication unit (2001) receives data or a code from the server (300). The protocol conversion unit (2002) converts the data or the code into a command that can be transmitted to the card (100). The communication unit (2001) passes the command converted by the protocol conversion unit (2002) to the card (100). When data conforming to command specifications of the card are received in advance from the server (300), the external device (200) transmits the received data, in unmodified form, to the card (100).

The card (100) has a communication unit (1001), a command interpretation unit (1002), a numerical computation unit (1004), a storage control unit (1003), a storage unit (1005), an encryption/decryption unit (1006), a checking unit (1007), a hash generation unit (1009), and a determination unit (1008). The communication unit (1001) receives data or a command from the external device (200). The command interpretation unit (1002) interprets the command received by the use of the communication unit (1001), and passes the thus-interpreted command to the numerical computation unit (1004). In accordance with a result of interpretation of the command performed by the command interpretation unit (1002), the numerical computation unit (1004) performs arrangement of data, conversion of data, and computation of data. The numerical computation unit (1004) also performs encryption processing by use of encryption/decryption unit (1006) that performs encryption/decryption processing as required; a checking unit (1007) that performs comparison and checking of data; a hash generation unit (1009) that generates a hash value of data; and a storage control unit (1003) that controls a storage unit (1005). The storage unit (1005) retains data in the card (100), and an access is made to the storage unit (1005) by way of the storage control unit (1003). The checking unit (1007) checks data to be signed against a signature stored in the encryption data decrypted by the encryption/decryption unit (1006). The determination unit (1008) determines correctness of the data on the basis of a result of checking performed by the checking unit (1007).

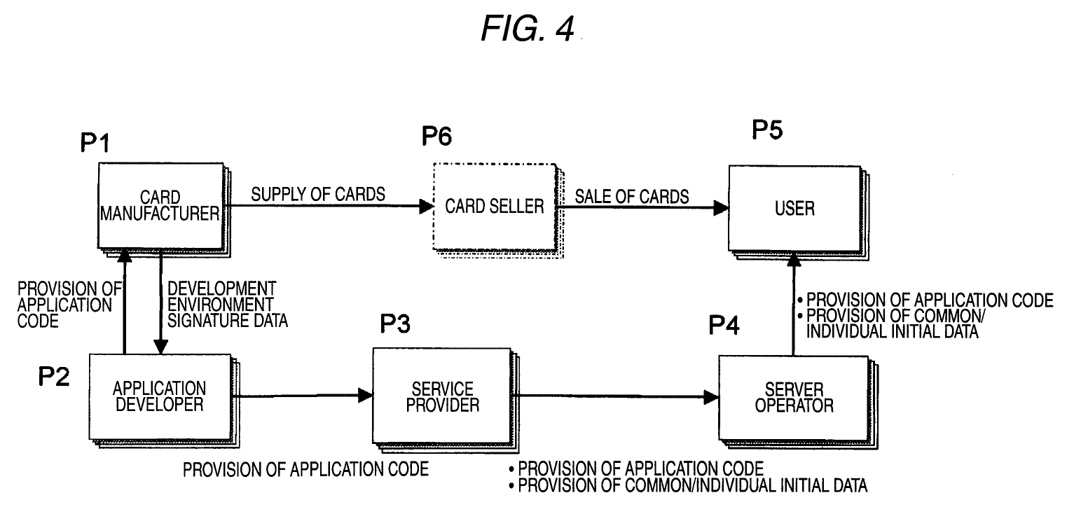

Aside from the system configuration, players engaged in manufacture of the card (100) and provision of applications and the like, will be described by reference to FIG. 4.

As shown in FIG. 4, there are present five players; namely, a player (P1) who manufactures and issues the card (100) (hereinafter called a “card manufacturer”); a player (P2) who develops applications (hereinafter called an “application developer”); a player (P3) who provides service (hereinafter called a “service provider); a player (P4) who operates a server (hereinafter called a “server operator”); and a player (P5) who casts a trigger for requesting data corresponding to the card from the server by operation of the external device (200) (hereinafter called a “user”). Although a card seller is present as a player (P6) who sells cards to the user from the operational viewpoint, the player is not directly relevant to the present embodiment, and hence its explanation is omitted.

The user (P5) has no special awareness of the other players (P1 through P4). However, the user and the other players are though to be separated from each other under the assumption that specifics of processing performed by the other players and specifics of processing performed by the user differ from each other in terms of the system. First, the card manufacturer (P1) performs processing from manufacture of cards to validation of cards that can be used in the market by setting data necessary for the cards; and lends the application developer (P2) a development environment and affixes a signature to an application code. Next, the application developer (P2) develops an application that can be distributed commonly, versatilely; and can provide a plurality of service providers (P3) with the application code in a versatile manner. Subsequently, the service provider (P3) incorporates information unique to a service, such as identification information or key information, into the application code received from the application developer (P2), thereby enabling customization of the application. The service provider (P3) is assumed to customize the application and run an actual service. The server operator (P4) operates a Web server that outputs data, in accordance with a request from the external device (200).

The player model described above is a mere example, and a case where a single player serve as several players and a case where processing pertaining to a single player is further splintered also fall within a category described in connection with the present patent application. For instance, there are also cases where the card manufacturer (P1) performs only manufacture of cards and where another player performs validation of the cards, lending of a development environment, and signing of an application code. There is also a conceivable case where the card seller, an explanation of which is omitted in the previous descriptions, validates cards at a shop or where the card manufacturer receives data prepared by the service provider and sets the thus-received data in a card. It is also conceivable that the service provider (P3) or the card manufacturer (P1) serves also as the application developer (P2).

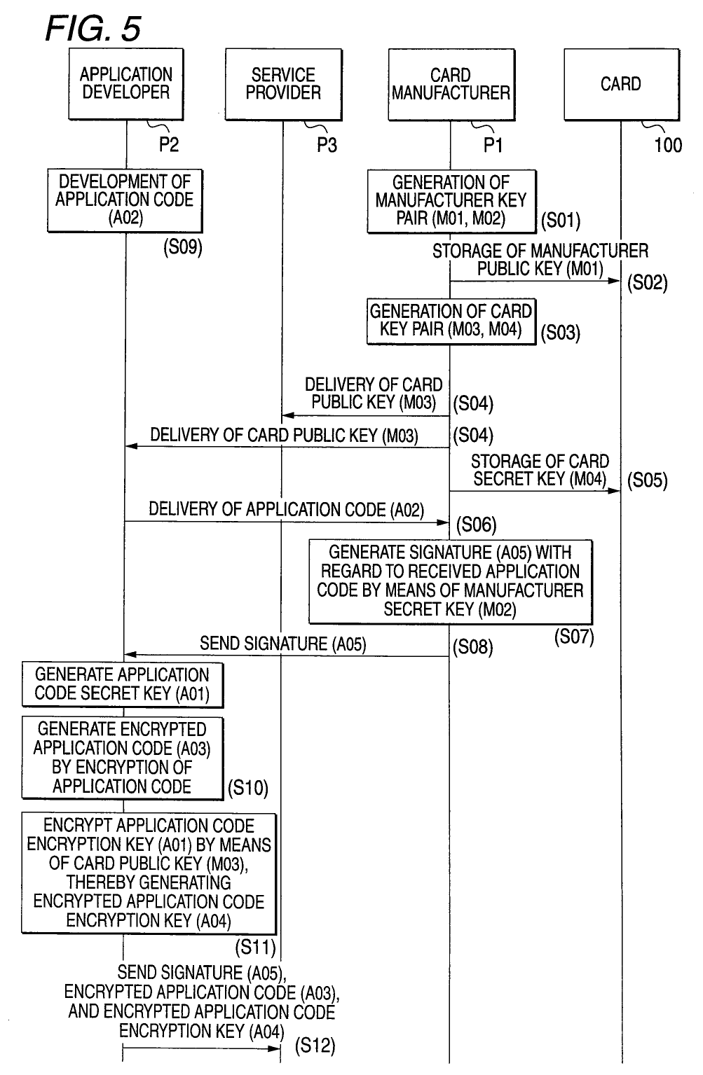

Processing performed by the respective players will now be described by reference to FIGS. 5, 6, 7-a, 7-b, and 7-c.

As shown in FIG. 5, the card manufacturer (P1) prepares a pair of RSA keys for the card manufacturer (a pair of manufacturer keys M01 and M02) in advance (S01). Of the thus-generated keys, the manufacturer public key (M01) is set (stored) in the card (100) (S02). A manufacturer secret key (M02) contrast to the manufacture public key (M01) is used when a signature is affixed to the application prepared by the application developer (P2). Next, the card manufacturer (P1) generates a pair of RSA keys (a pair of card keys M03, M04) stored in a card (100) to be manufactured (S03). Of the thus-generated keys, the card public key (M03) is distributed to the application developer (P2) and the service provider (P3) (S04). In the meantime, the card secret key (M04) is stored in the card (100) (S05). The manufacture keys (M01 and M02) and the card keys (M03 and M04), which are manufactured by the card manufacturer (P1), may be the RSA keys or keys utilizing another public key encryption scheme, such as an elliptic encryption scheme, a DH key exchange scheme, and an ElGamal cipher scheme. Likewise, the length of the RSA key is not limited to 1024 bits or 2048 bits but may also be freely changed in accordance with a security policy for operation of cards.

A signature is affixed to an application code by means of filing of an application performed by the application developer (P2); namely, delivery of an application code to the card manufacturer (P1) (S06). The card manufacturer (P1) ascertains details of operation of the submitted application. If there are no problems, hash data pertaining to the submitted application code are prepared. The card manufacturer (P1) generates a signature (A05) for the thus-prepared hash data by the use of the manufacturer secrete key (M02) (S07). The thus-generated signature (A05) is sent to the application developer (P2) (S08).

The application developer (P2) is in advance provided with a development environment and the card public key (M03), which correspond to the card (100), from the card manufacturer (P1). The application developer (P2) develops an application code corresponding to the card (100) by utilization of the development environment (S09). The application code completed in step S09 is an application code (A02) sent to the card manufacturer (P1) in step S06.

On transferring the thus-prepared application code to the service provider (P3), the application developer (P2) passes the application code after having encrypted the code. The reason for encryption is that only the application developer (P2) can develop the application code by use of the development environment given by the card manufacturer (P1) and that, if the application code is transferred to the service provider (P3) without being encrypted, the service provider (P3) can browse specifics of the application code and leak secret information. Another conceivable problem is a party who is liable for leakage of secret information that has arisen when a code is passed without being encrypted and when a plurality of players share the secret information.

In this regard, in the present embodiment, the application developer (P2) encrypts the application code (A02) by means of an encryption key (A01) originally developed by the developer (hereinafter called an “application code encryption key”), thereby generating an encrypted application code (A03) (S10). The application developer (P2) encrypts the application code encryption key (A01) by means of the previously-distributed card public key (M03), thereby generating an encrypted application code encryption key (A04) (S11). Subsequently, the application developer (P2) transfers to the service provider (P3) the encrypted application code (A03), the encrypted application code encryption key (A04), and the signature (A05) for the application code (S12). The service provider (P3) can decrypt neither the encrypted data (A03 and A04).

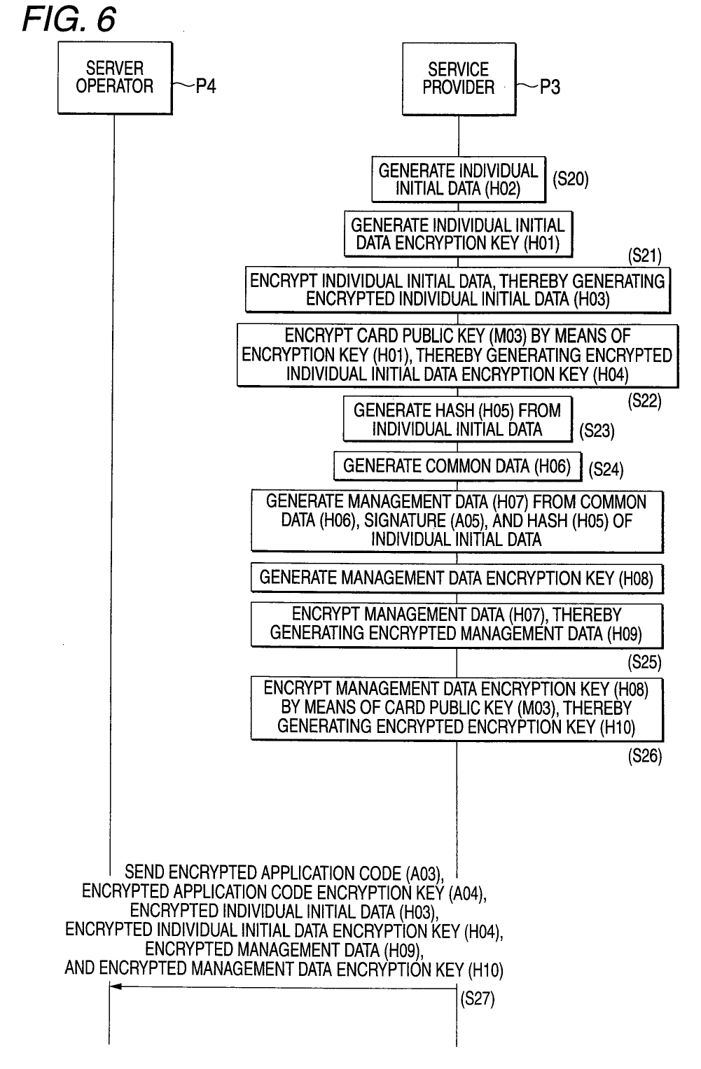

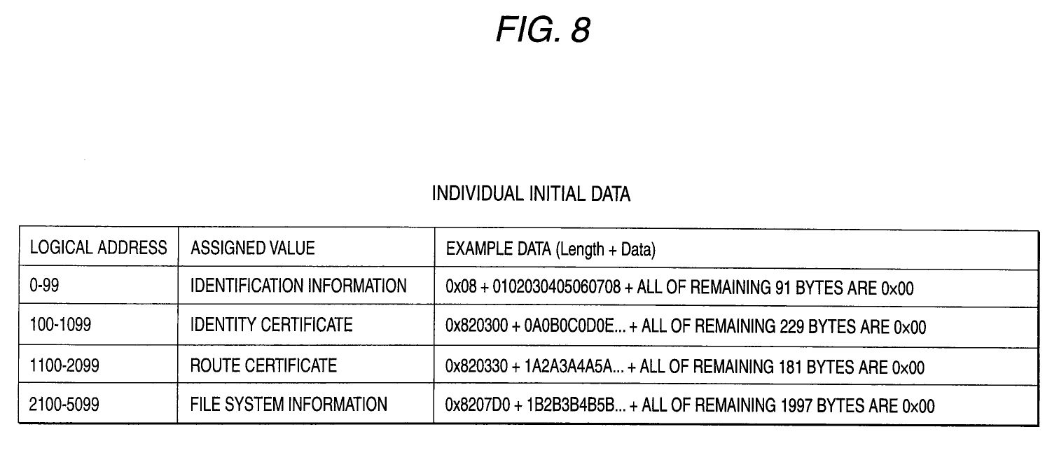

Next, operation performed by the service provider (P3) is described by reference to FIG. 6. The service provider (P3) prepares application data (H02) for individually customizing the application code received from the application developer (P2) (hereinafter called “individual initial data”) (S20). Individually changing all data to be prepared for each application or standardizing all of the data for applications is dependent on the policy of service operation, and hence no consideration is given to this matter. On preparing individual initial data (H02), the service provider (P3) must separately receive external specifications of the application from the application developer (P2). As shown in FIG. 8, external specifications of making a reference to an application by means of taking first 100 bytes (logical addresses 0 to 99) as identification information; subsequent 1000 bytes (logical addresses 100 to 1099) as identity certificate data; subsequent 1000 bytes (logical addresses 1100 to 2099) as route certificate data; and subsequent 3000 bytes (logical addresses 2100 to 5099) as file system information, are adopted as an example data structure of the individual initial data. Information showing a length is set at a starting point of data, thereby indicating an extent to which the application is to make a reference as effective data.

Turning back to FIG. 6, like the application developer (P2), the service provider (P3) encrypts the prepared individual initial data (H02) by means of the originally prepared key (H01) (hereinafter called an “individual initial data encryption key”), thereby preparing encrypted individual initial data (H03) (S21). The service provider (P3) encrypts the individual initial data encryption key (H01) by means of the card public key (M03) previously distributed from the card manufacturer (P1), to thus prepare an encrypted individual initial data encryption key (H04) (S22). At this time, the service provider (P3) prepares hash (H05) for the thus-prepared individual initial data (H02) (S23).

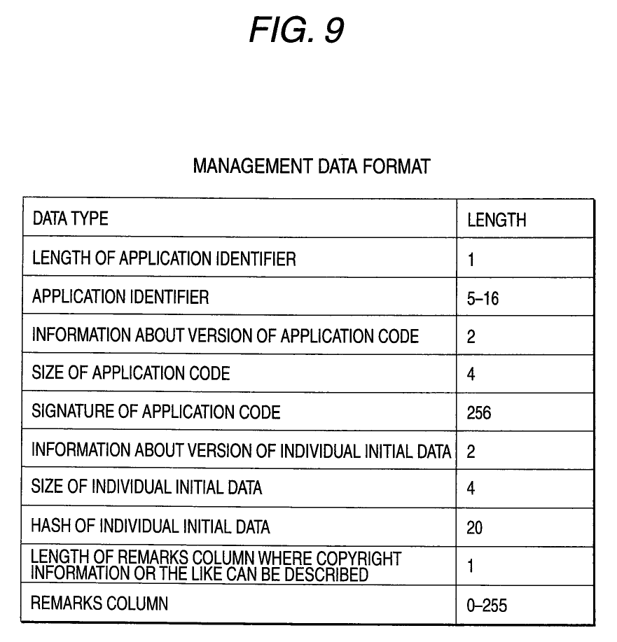

The service provider (P3) generates management data (H07) from the thus-generated hash (H05), the signature (A05) received from the application developer (P2), and common data (H06). The common data (H06) include identification information prepared by the service provider (P3) for identifying an application (S24), application management information such as copyright information, or service provider information, and the like. FIG. 9 shows an example format of the management data (H07).

The service provider (P3) encrypts the management data (H07) by means of the originally generated key (hereinafter called a “management data encryption key (H08)”), thereby preparing encrypted management data (H09) (S25). Subsequently, the service provider (P3) encrypts the management data encryption key (H08) by the use of the card public key (M03) previously distributed from the card manufacturer (P1), thereby preparing an encrypted management data encryption key (H10)(S26).

Since the individual initial data encryption key (H01) and the management data encryption key (H08) are prepared and managed by the service provider (P3), an identical key may also be prepared, or keys may also be prepared separately. When keys are prepared separately, labor for management is increased. However, security measures against leakage of a key are further enhanced, and hence the present embodiment describes a case where the individual initial data encryption key and the management data encryption key are separately prepared.

The service provider (P3) distributes to the server operator (P4) the encrypted application code (A03) received from the application provider (P2), the encrypted application code encryption key (A04), the encrypted individual initial data (H03), the encrypted individual initial data encryption key (H04), the encrypted management data (H09), and the encrypted management data encryption key (H10) (S27). The server operator (P4) cannot decrypt all of the received encryption data (A03, A04, H03, H04, H09, and H10).

The present embodiment has described the case where, in consideration of a time consumed by encryption/decryption of data and a key length, the common key encryption scheme is used as an encryption algorithm employed for the application code encryption key (A01), the individual initial data encryption key (H01), and the management data encryption key (H08). However, the encryption algorithm is not limited to the common key encryption scheme, and a public key encryption scheme may also be used. Although AES of the common key encryption scheme is used in the present embodiment, the common key encryption scheme is not limited to the AES, and another common key encryption scheme known as DES, T-DES, MISTY, Camellia, RC6, and the like, may also be adopted. The present invention will be compatible with a common key encryption scheme which will be released in the future, so long as the card is compatible with the encryption scheme.

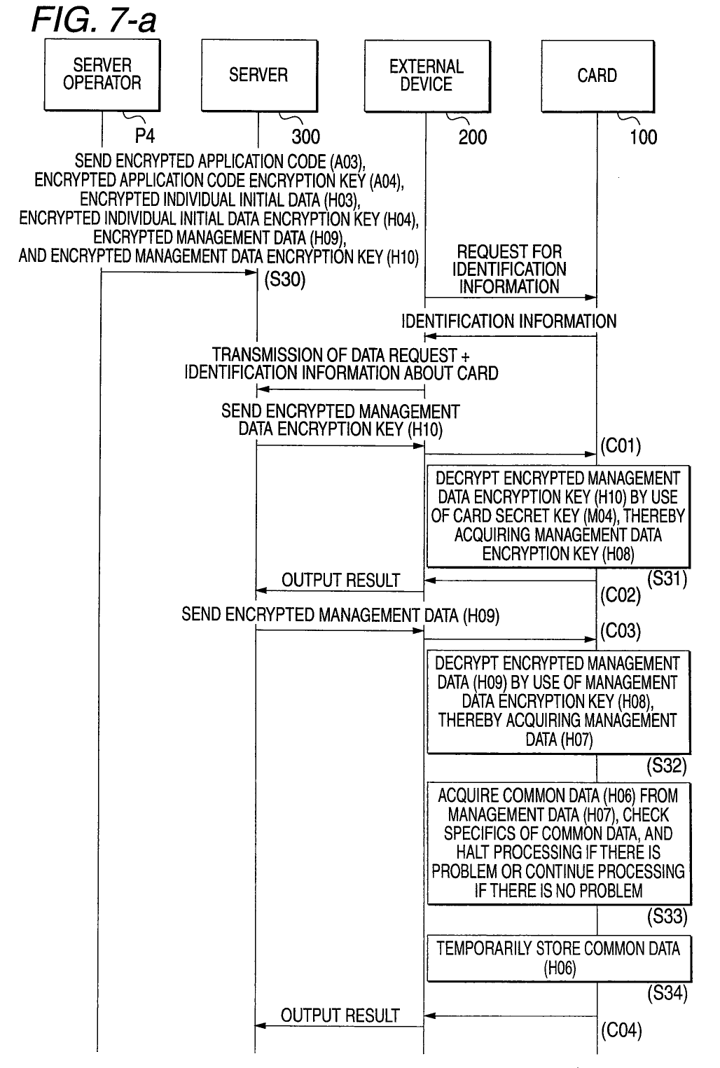

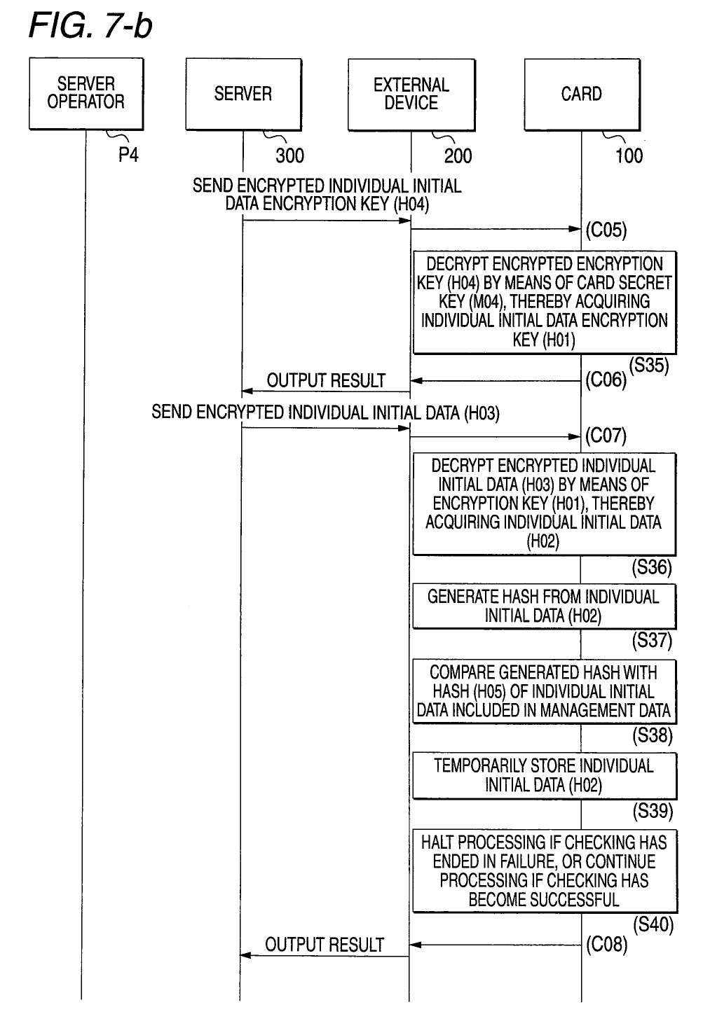

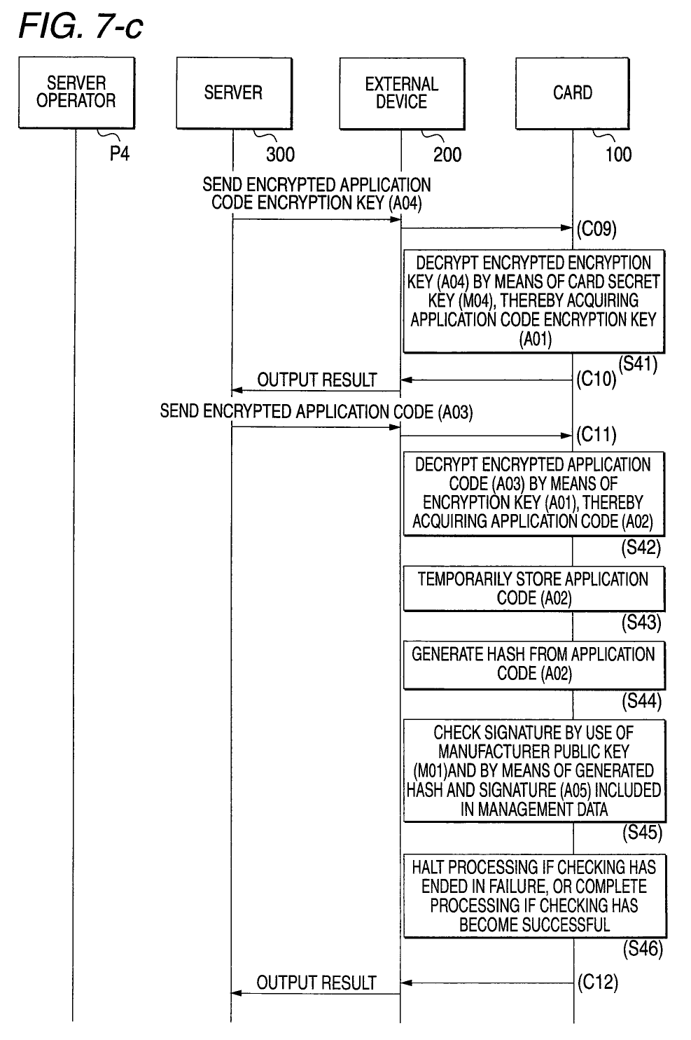

Subsequently, descriptions are provided by reference to FIG. 7-a. The server operator (P4) registers the data received in S27 in FIG. 6 into the storage unit (3003) of the server (300) (S30). At the time of registration, the server (300) must know the type and version of a card with which the data received from the service provider (P3) are compatible. Identification information about a card is example information showing the type and version of a card. The card identification information is acquired by the external device (200) from the card (100) and transmitted along with a request for data when the request is sent to the server (300). In order to transmit to an external device a plurality of sets of encrypted data corresponding to the identification information, the server (300) must know identification information beforehand. These sets of data correspond to information notified by the service provider (P3) or the application developer (P2), separately.

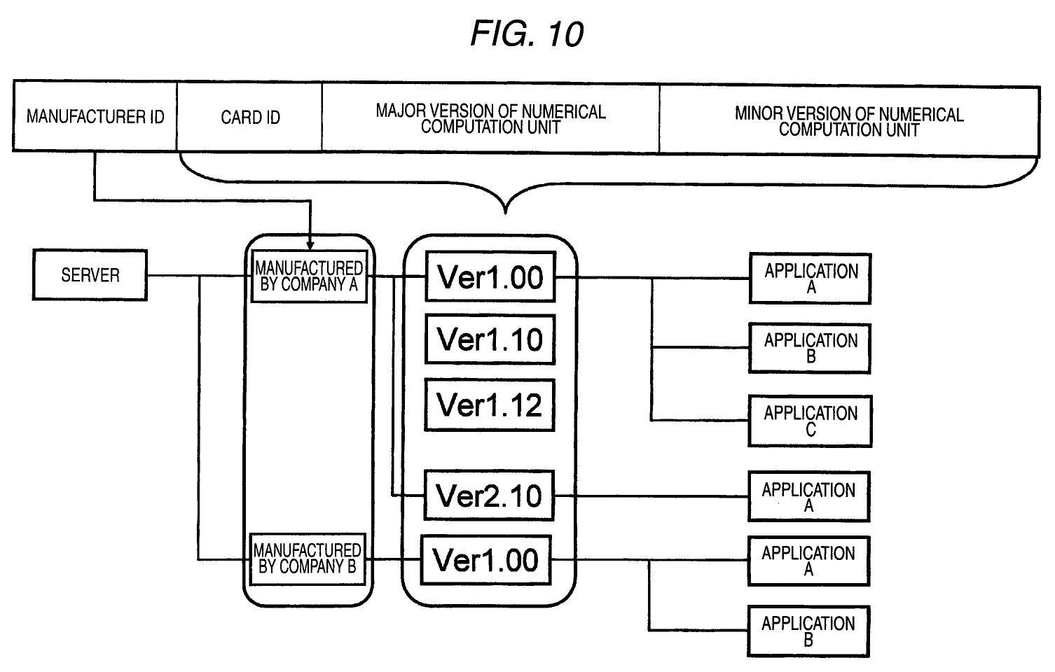

FIG. 10 shows example version information output from the card and a corresponding example format for managing data in the server. A command is specified for the purpose of output of the identification information (a card ID in FIG. 10) from the card, and identification information about the card is notified to the external device by means of response data corresponding to the command. The command is exchanged in negotiations specified by an application or communications layer stored in the card. When only cards of one version are operated, information about the type and version of a card does not need to be exchanged beforehand.

The server (300) transmits data in response to the data request form the external device (200) in sequence of the management data encryption key, the management data, the individual initial data encryption key, the individual initial data, the application code encryption key, and the application code. The sequence is preferable for sequentially processing the data as much as possible in the card without temporarily saving the data. When a sufficient temporary storage area is present in the card, the sequence is not limited to that mentioned above.

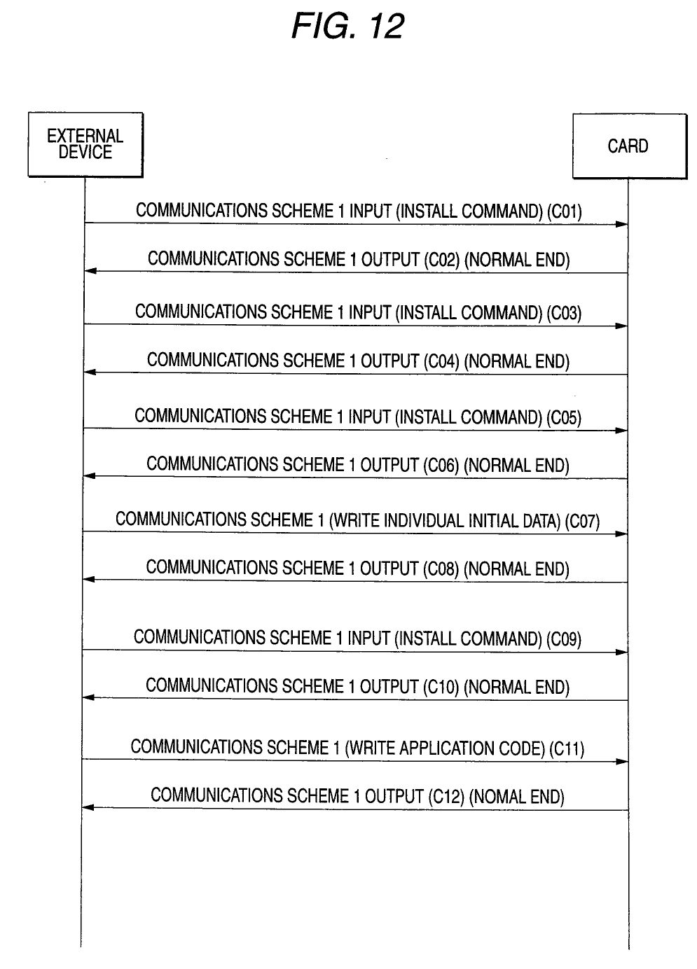

FIG. 12 shows a flow of communication exchanged between the card (100) and the external device (200). Descriptions are provided hereunder also by reference to FIG. 7-a.

In the card (100), the communication unit (1001) first receives the encrypted management data encryption key (H10) by way of the external device (200) (C01), and passes the thus-received key to the command interpretation unit (1002). The command interpretation unit (1002) checks the command imparted to the encrypted management data encryption key (H10), thereby interpreting what is indicated by the command and the purpose of use of the command. In the present embodiment, specifics of the command describe the following operation on the assumption that an application would be installed in the card (100). The command interpretation unit (1002) notifies the numerical computation unit (1004) that processing is installation of an application, and passes the received data to the numerical computation unit. The numerical computation unit (1004) acquires the card RSA secrete key (M04) retained in the storage unit (1005) by way of the storage control unit (1003), and decrypts the received data by the encryption/decryption unit (1006) (S31). In S31, the card (100) decrypts the encrypted management data encryption key (H10) by use of the card secret key (M04), thereby acquiring the management data encryption key (H08). The numerical computation unit (1004) retains the decrypted management data encryption key (H08) in the storage unit (1005) by way of the storage control unit (1003). When foregoing processing is performed without involvement of problems, the card (100) outputs to the external device (200) and the server (300) a code signifying normal end (C02).

The communication unit (1001) next receives the encrypted management data (H09) by way of the external device (C03). The numerical computation unit (1004) decrypts through use of the management data encryption key (H08) the management data (H09) encrypted by the encryption/decryption unit (1006), thereby acquiring the management data (H07) (S32). The management data (H07) acquired through decryption comply with the previously defined format (FIG. 9), and hence the numerical computation unit (1004) reads data in accordance with the format. The information for identifying an application is used for checking whether or not an application having the same identification information is already present in the card (S33). In S33, the card (100) acquires the common data (H06) from the management data (H07), and ascertains specifics of the thus-acquired data. When a checking result shows a problem, the card (100) stops processing. In contrast, when the result shows no problem, the card (100) continues performance of processing. Specifically, when there is the same identification information; in other words, when a result of checking of specifics of the common data (H06) acquired from the management data (H07) shows a problem, the numerical computation unit (1004) halts (stops) installation processing. When outputting the result to the external device (200) (C04), the numerical computation unit (1004) outputs the result not as normal end but as an error code showing an overlap of identification information. When there is no overlap, the common data (H06) are tentatively stored in the storage unit (1005) by way of the storage control unit (1003) (S34). An output of the result is not limited to the error. When anomalous operation is detected, the numerical computation unit (1004) outputs a code to the effect that communication has already been previously exchanged with the outside.

Next, descriptions are provided by reference to FIG. 7-b. In the card (100), the communication unit (1001) receives the encrypted individual initial data encryption key (H04) by way of the external device (200) (C05), and passes the thus-received key to the numerical computation unit (1004). The numerical computation unit (1004) decrypts the encrypted individual initial data encryption key (H04) by means of the encryption/decryption unit (1006) and by the use of the card RSA secret key (M04) retained in the storage unit (1005), thereby acquiring the individual initial data encryption key (H01) (S35). The card (100) retains the decrypted individual initial data encryption key (H01) in the storage unit (1005). Next, the communication unit (1001) receives from the server (300) the encrypted individual initial data (H03) by way of the external device (200) (C07). The communication unit (1001) passes the data to the numerical computation unit (1004). The numerical computation unit (1004) decrypts the encrypted individual initial data (H03) through use of the individual initial data encryption key (H03) and by means of the encryption/decryption unit (1006), thereby acquiring the individual initial data (H02) (S36). The application code (A02), which will be described later, interprets specifics of the individual initial data (H02), and the card (100) does not need to interpret the specifics. The numerical computation unit (1004) generates hash for the decrypted individual initial data (H02) by means of the hash generation unit (1009) (S37), and checks, by the use of the checking unit (1007), whether or not the thus-generated hash is identical with the hash (H05) of the individual initial data included in the management data (S38). When the hash is identical, the numerical computation unit (1004) tentatively stores the individual initial data (H02) in the storage unit (1005) by way of the storage control unit (1003) (S39). When the thus-generated hash is different, the numerical computation unit (1004) halts installation processing (S40). On outputting a result to the external device (200) and the server (300) (C08), the card (100) outputs not normal end but an error code to the effect that the hashes are different.

Next, descriptions are provided by reference to FIG. 7-c. In the card (100), the communication unit (1001) receives from the server (300) the encrypted application code encryption key (A04) by way of the external device (200) (C09), and passes the key to the numerical computation unit (1004). The numerical computation unit (1004) decrypts the encrypted application code encryption key (A04) by the use of the card RSA secret key (M04) retained in the storage unit (1005) and by means of the encryption/decryption unit (1006), thereby acquiring an application code encryption key (A01) (S41). The card (100) retains the decrypted application code encryption key (A01) in the storage unit (1005). The communication unit (1001) next receives from the server (300) the encrypted application code (A03) by way of the external device (200) (C11). The communication unit (1001) passes the data to the numerical computation unit (1004). The numerical computation unit (1004) decrypts the encrypted application code (A03) by the use of the application code encryption key (A01) and by means of the encryption/decryption unit (1006), thereby acquiring the application code (A02) (S42). The application code (A02) is based on the assumption that operation of the application code is previously checked by a manufacturer, and hence the card (100) does not need to newly verify operation of the application code. The numerical computation unit (1004) tentatively stores the application code (A02) in the storage unit (1005) by way of the storage control unit (1003) (S43). The card generates hash of the decrypted application code (A02) by means of the hash generation unit (1009) (S44). The numerical computation unit (1004) decrypts the signature (A05) by the use of the manufacturer public key (M01) and by means of the encryption/decryption unit (1006), thereby acquiring hash and then checking the acquired hash against the hash of the generated application code by means of the checking unit (1007) (S45). When the hashes are identical with each other, the numerical computation unit (1004) stores the application code (A02) in the storage unit (1005). When the hashes are different from each other, the numerical computation unit (1004) halts installation processing (S46). On outputting a result to the external device (200) and the server (300) (C10), the numerical computation unit (1004) outputs not normal end but an error code that the signature is different. When the signature is identical, the numeral computation unit (1004) ascertains that all of the data are normal; notifies a result of ascertainment to the determination unit (1008); and completes installation processing. Upon receipt of the notification that the signature is valid, the determination unit (1008) determines the hash of the individual initial data encrypted along with the signature and the common data to be valid, and makes the common data, the individual initial data, and the application code relevant to the application operable in the card. Specifically, the storage unit (1005) manages the status of the application. In response to a request from the external device (200), the numerical computation unit (1004) ascertains the status from the storage unit (1005) by way of the storage control unit (1003). When the application is indicated as being operable, the storage unit (1005) operates so as to call the application code and pass the command sent from the command interpretation unit (1002) to the application code.

In relation to the downloading method and the installation method of the present invention, a final point of reliability resides in ascertainment of a signature of an application code. When ascertainment of a signature normally ends, the hash of individual initial data stored in encrypted data in conjunction with the signature is trusted, and the individual initial data matching the hash is trusted too. The signature data are imparted by the manufacturer, and a manufacture secret key used for generating a signature is not stored in cards and not distributed in the market. Therefore, the risk of leakage of the secret key is low. Moreover, the application developer (P2) and the service provider (P3) originally generate keys. Even if either party leaked a key, the other party will not be affected by the leakage of the key. Further, since a public key encryption scheme is adopted for a method of distributing the originally generated key, it is impossible even for other application developers or service providers to decrypt the key, and only the card holding the secret key can decrypt the key.

Procedures for updating the data will now be described.

When mutual authentication is not performed, the server has no method to prevent masquerading of cards, and the cards also have no method to prevent masquerading of the server. Hence, the server cannot manage which cards have undergone installation of an application, and the cards do not recognize which service provider is the provider of the installed application. Therefore, when the application installed in the card is updated, the card cannot ascertain whether or not the application is distributed from the same service provider. The application can be temporarily deleted and then reinstalled. However, since a relationship between the original application and an application for updating purpose cannot be verified at the time of updating operation, there arises a problem of an inability to implement update processing for changing only a data processing section while leaving part of data in a card. Accordingly, there will be described below a method for, when an installed application is updated by the use of the previously-described downloading and installation methods, verifying that updating of the application is performed by an appropriate service provider without involvement of external authentication and implementing update processing.

As mentioned previously, three types of data; namely, management data, individual initial data, and an application code are present as data. The management data are inevitably present for storing individual initial data and data relevant to an application code. However, there are cases where only individual initial data or an application code is updated.

When only individual initial data are updated, the hash (H05) of the individual initial data and identification information (common data) (H06) about an application to be updated are stored in the management data; the management data are encrypted: and the thus-encrypted management data are transmitted along with the encrypted individual initial data. When only an application code is updated, a signature of an application code and identification information (common data) (H06) about an application to be updated are stored in the management data; the management data are encrypted; and the thus-encrypted management data are transmitted along with the encrypted application code.

As mentioned previously, in relation to the downloading method and the installing method of the present invention, the point of reliability is placed in signature data. In the case of updating of only individual initial data, the signature data (A05) are not included, and the cards cannot prove reliability. Therefore, at the time of initial installation of an application, an individual initial data encryption key is saved in the card along with the application in preparation for the case of performance of updating. At the time of updating operation, a key is not decrypted from the key data encrypted by the public key but decrypted by utilization of the individual initial data encryption key previously held in the card. There can be used an individual initial data encryption key that only the service provider can know. Coincidence between the hash of the decrypted data and the hash sent by means of the management data shows that the provider is the service provider (P3) who initially installed the application or a representative service provider having information equivalent to the individual initial data encryption key. As a result of use of this method, the same service provider that initially installed the application can be restricted solely to a player capable of performing an update by means of only a card, without involvement of external authentication, which would otherwise be performed by the card, or application management, which would otherwise be performed by the server.

Even in relation to the application code, update processing can be restricted solely to the application developer (P2) that initially installed the application by utilization of the method. Since the application code is provided with the signature (A05), the application code itself is impervious to tampering. However, a relationship between the application code and the individual initial data (H02) cannot be found at the time of updating operation. Hence, a reference can be made to individual initial data of another application by replacing only the application code portion with an application code of another individual initial data already installed in the card. It is therefore important to impose a limitation on an update by means of a countermeasure such as that mentioned above.

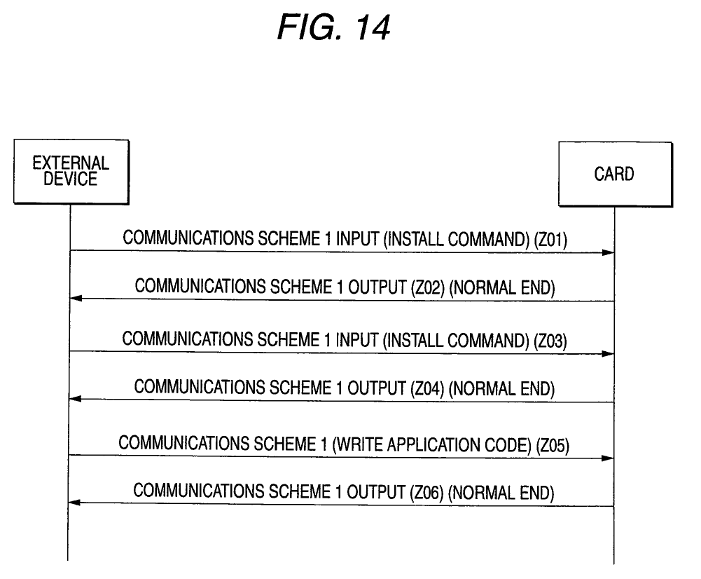

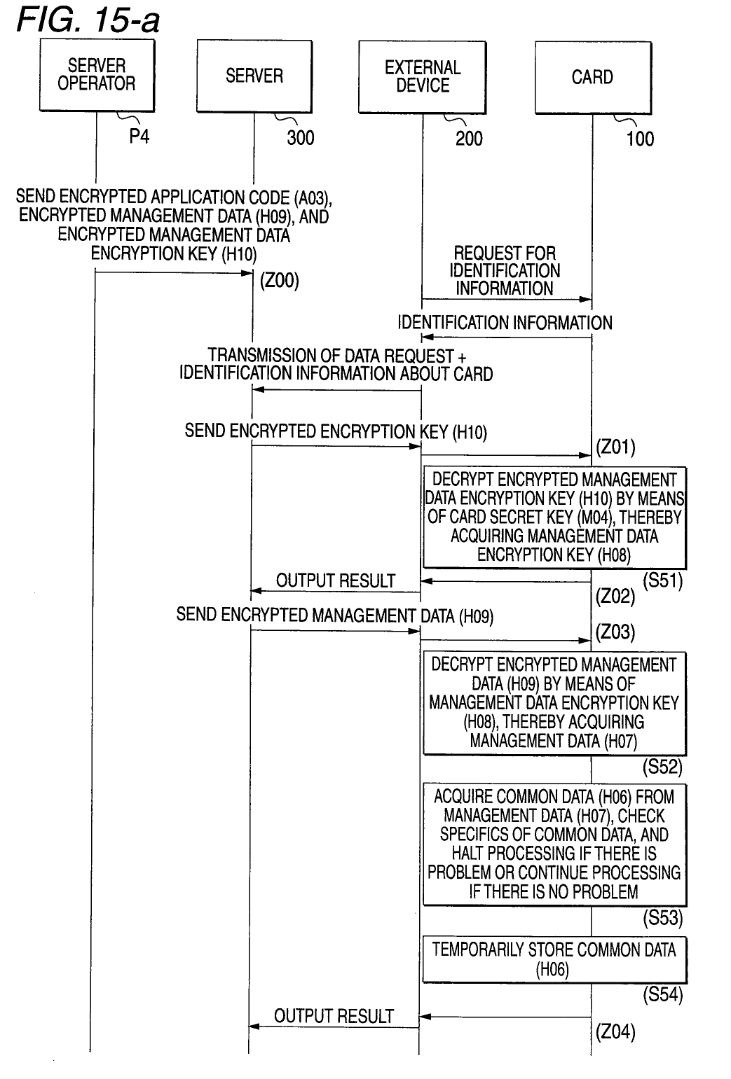

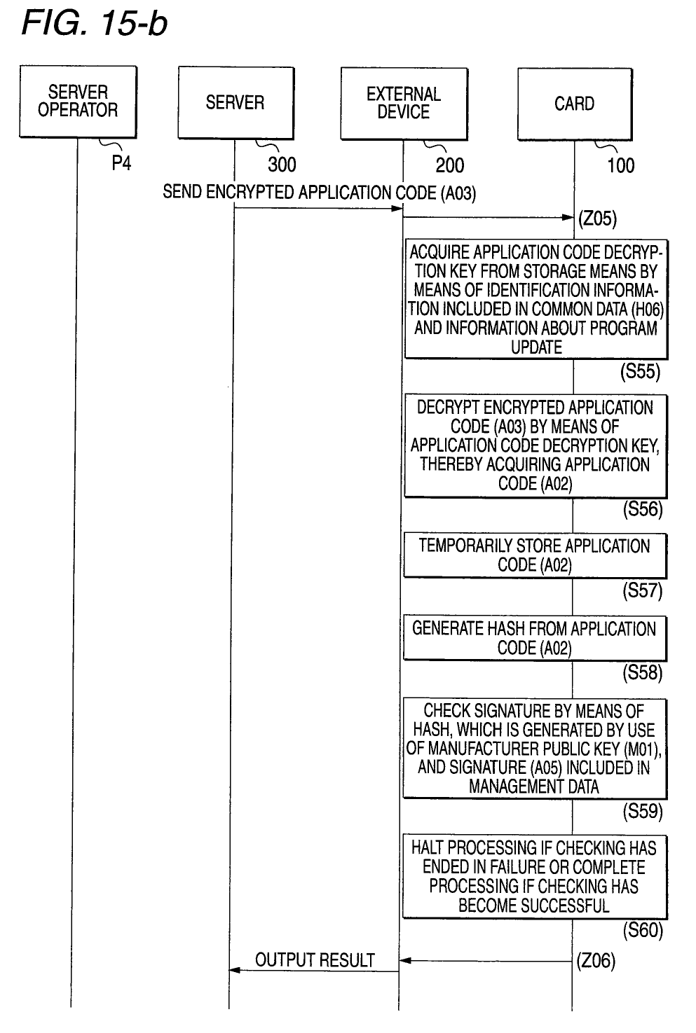

FIG. 14 shows a flow of communication established between the card (100) and the external device (200), and flows of processing performed by the respective players will be described by reference to FIGS. 15-a and 15-b.

Processing in which the application developer again develops an application code; in which the application code is supplied to the server operator by way of the service provider; and in which the thus-supplied code is registered as encrypted data by the server operator is compared with preparation of data involving new installation. A difference between the processing and the preparation of data resides only in that the service provider does not generate individual initial data and that hash of the individual initial data is not included in management data. Hence, an explanation of the processing flow is omitted.

An explanation is first provided by reference to FIG. 15-a. The server operator (P4) registers, as applications for updating purpose, the encrypted application code (A03) and the encrypted management data (H09), and the encrypted management data encryption key (H10), all of which are supplied by the service provider (P3), into the server (300) (ZOO). At this time, in order to respond to a request from the external device (200), version information, explanations, and others, pertaining to the application for updating purpose are imparted to the application, thereby making the application explicitly recognizable from the outside. Alternatively, when some type of information is previously included in the update request from the external device (200), the server (300) distributes the application in response to the information. At that time, the information transmitted from the external device (200) includes identification information about the application, information about the version of the current application stored in a card, identification information about a card, and the like.

In the card (100), the communication unit (1001) first receives the encrypted management data encryption key (H10) from the server (300) by way of the external device (200) (Z01), and passes the thus-received key to the command interpretation unit (1002). The command interpretation unit (1002) checks the command imparted to the data, thereby interpreting what is indicated by the command and the purpose of use of the command. Specifics of the command describe the following operation on the assumption that there will be performed processing for updating an application code. Determination of update processing includes a method for ascertaining whether or not processing is update processing by use of the command interpretation unit (1002) and a method for first taking processing as installation processing, to thus ascertain the status of an application corresponding to an identifier of the application, and automatically ascertaining processing to be subsequently performed as update processing by means of the card (100). The present embodiment describes a case where interpretation is performed by means of a command, to thus determine the nature of processing.

The command interpretation unit (1002) notifies the numerical computation unit (1004) that processing is updating of an application code, and passes received data to the numerical computation unit (1004). The numerical computation unit (1004) acquires the card RSA secrete key (M04) retained in the storage unit (1005) by way of the storage control unit (1003); and decrypts the received data by means of the encryption/decryption unit (1006), thereby acquiring the management data encryption key (H08) (S51). The numerical computation unit (1004) retains the decrypted management data encryption key (H08) in the storage unit (1005) by way of the storage control unit (1003) (S51). When foregoing processing can be performed without involvement of problems, the card (100) outputs to the external device (200) and the server (300) a code signifying normal end (Z02).

The communication unit (1001) next receives the encrypted management data (H09) from the server (300) by way of the external device (200) (Z03). The numerical computation unit (1004) decrypts through use of the management data encryption key (H08) the management data (H09) encrypted by the encryption/decryption unit (1006), thereby acquiring the management data (H07) (S52). Since the decrypted management data (H07) comply with the previously-defined format (FIG. 9), the numerical computation unit (1004) reads data in accordance with the format. In the case of updating, not all of the data are included, and the essential requirement is that required information be included at the time of update processing. The present embodiment corresponds to updating of an application code, and hence it is not matter if version information about individual initial data, the size of the individual initial data, and hash of the individual initial data will not be described. The length of an application identifier, an application identifier, version information about an application code, the size of an application code, and a signature (A05) of an application code become indispensable. The information for identifying an application is used for checking whether or not an application for updating is present in the card (100) (S53). Moreover, on the basis of the status of the application retained in the storage unit (1005), a check is made as to whether or not an application which is a target of updating is held in an updatable state. When the same identification information is not available or when an update is not possible, the numerical computation unit (1004) halts (stops) installation processing. When outputting a result to the external device (200) and the server (300) (Z04), the numerical computation unit (1004) outputs the result not as normal end but as an error code showing absence of the target application. When the target application is present, the card (100) tentatively stores the common data in the storage unit (1005) by way of the storage control unit (1003) (S54). An output of the result is not limited to the error. When anomalous operation is detected, a code to the effect that communication has already been previously exchanged with the outside is output.

Next, descriptions are provided by reference to FIG. 15-b. In the card (100), the communications unit (1001) receives the encrypted application code (A03) from the server (300) by way of the external device (200) (Z051). The communication unit (1001) passes the thus-received data to the numerical computation unit (1004). On the basis of the identifier of the application that is the target of updating and information about updating of the application code, the numerical computation unit (1004) acquires from the storage unit (1005) the application code encryption key (A01) obtained by decryption of the data at the time of storage of the first data (S55). The encryption/decryption unit (1006) decrypts the encrypted application code (A03) by the use of the application code encryption key (A01) (S56). The application code is based on the assumption that operation of the application code is previously checked by a manufacturer, and hence the card (100) does not need to newly verify operation of the application code. The numerical computation unit (1004) tentatively stores the application code in the storage unit (1005) by way of the storage control unit (1003) (S57). The card (100) generates hash of the decrypted application code (A02) by means of the hash generation unit (1009) (S58). The numerical computation unit (1004) decrypts the signature (A05) by the use of the manufacturer public key (M01) and by means of the encryption/decryption unit (1006), thereby acquiring hash and then checking the acquired hash against the hash of the generated application code by means of the checking unit (1007) (S59). When the hashes are identical with each other, the numerical computation unit (1004) stores the application code (A02) in the storage unit (1005). When the hashes are different from each other, the numerical computation unit (1004) halts installation processing (S60). On outputting a result to the external device (200) and the server (300) (Z06), the numerical computation unit (1004) outputs not normal end but an error code that the signature is different. When the signature is identical, the numeral computation unit (1004) ascertains that all of the data are normal; notifies a result of ascertainment to the determination unit (1008); and completes installation processing. Upon receipt of the notification that the signature is valid, the determination unit (1008) determines the common data encrypted along with the signature to be valid, and makes the common data and the application code relevant to the application operable in the card.

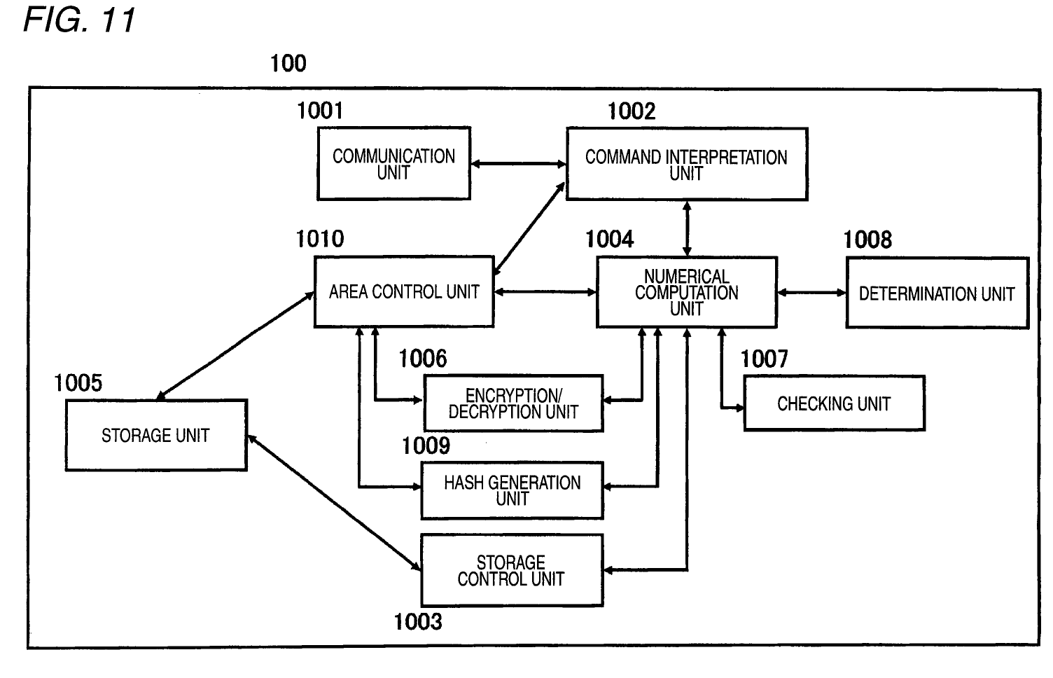

Although the previous explanations do not provide detailed descriptions about a communications channel between the external device (200) and the card (100). However, there is a card (FIG. 11) having two channels; namely, a communications channel that can make an access to the storage section at high speed but requires designation of an area beforehand (hereinafter called a “high-speed communications channel”) and a communications channel that is inferior to the high-speed communications channel in terms of speed but performs designation of an area by means of internal interpretation (hereinafter called a “low-speed communications channel”).

When the card is compatible with a plurality of communications schemes, it may be the case where, depending on the nature of processing, a scheme is desired to be changed in the middle of installation. When data in the server are encrypted, the server and the external device cannot determine the nature of the encrypted data and ascertain switching timing. Moreover, even when the server has switching timing as another plain information in advance, there is a problem of, when switching is designated by way of an external device, the card that has not yet been able to authenticate the external device being unable to trust a command. Accordingly, there is provided a method for appropriately, dynamically switching a plurality of communications methods provided in the card even when the previously descried downloading and installing methods are used.

The management data (H07) whose nature is interpreted by the card (100), to thus store data, must be written by the use of the low-speed communications channel. However, the individual initial data (H02) and the application code (A02), whose natures cannot be interpreted by the card, can be written by the use of the high-speed communications channel. In particular, when the individual initial data (H02) and the application code (A02) are of large size, an effect of use of the high-speed communications channel is large, and shortening of an installation time can be achieved. Further, when the low-speed communications channel and the high-speed communications channel are separated from each other, the data become uncertain as to whether or not the data have been sent from a normal external device (200). However, in this regard, the signature data (A05) and the hash (H05) can guarantee the relationship between the two communications channel, and hence no problem arises.

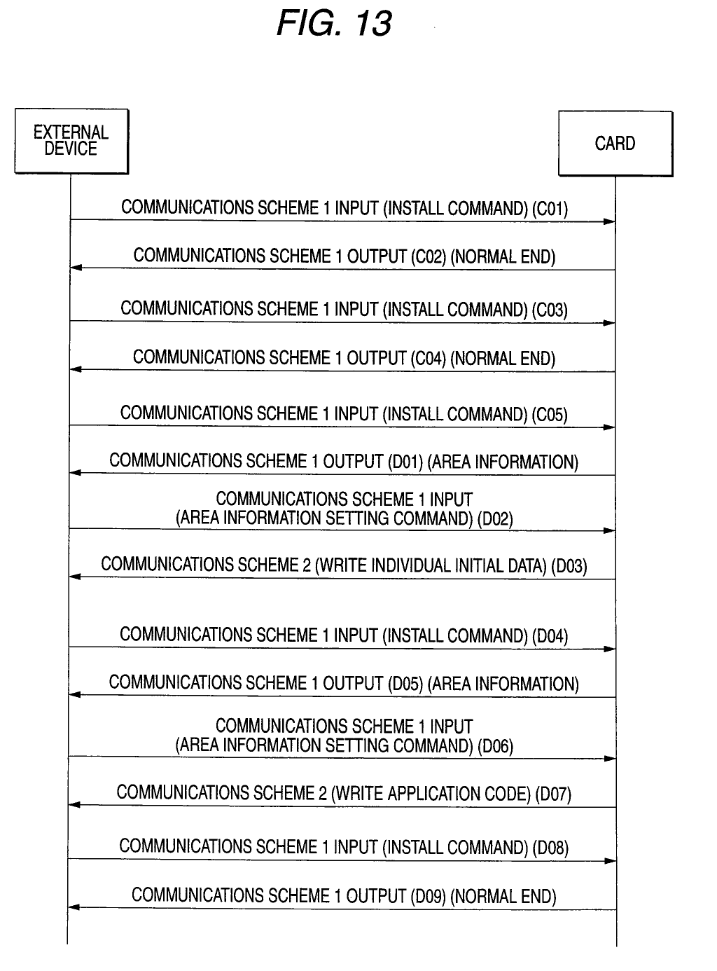

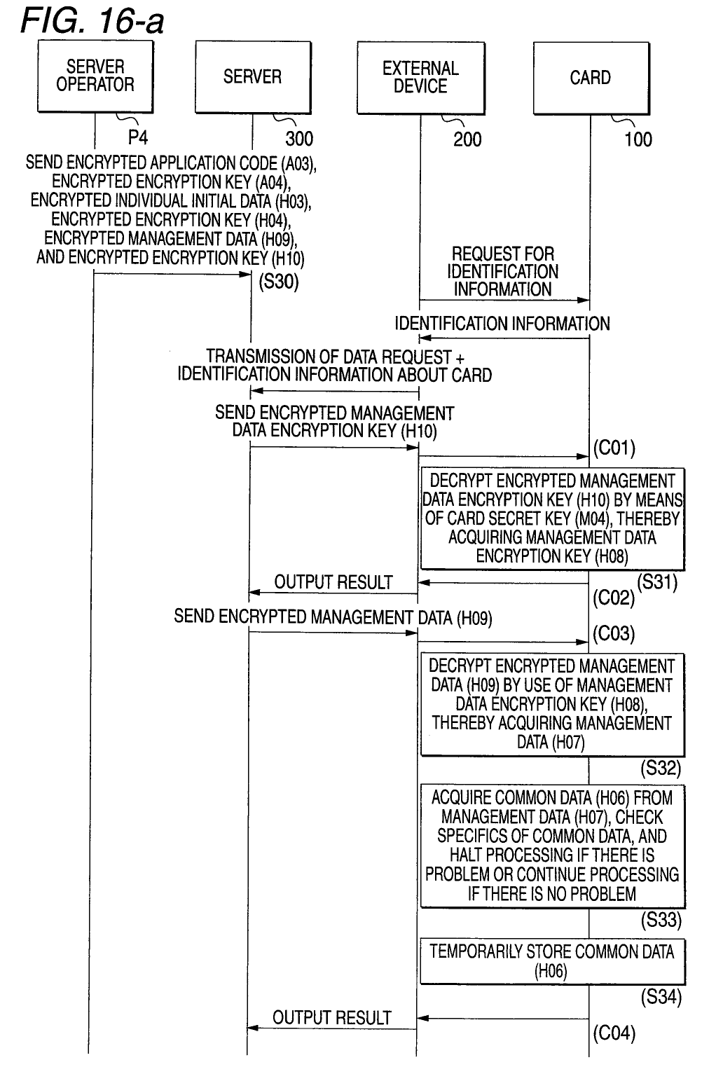

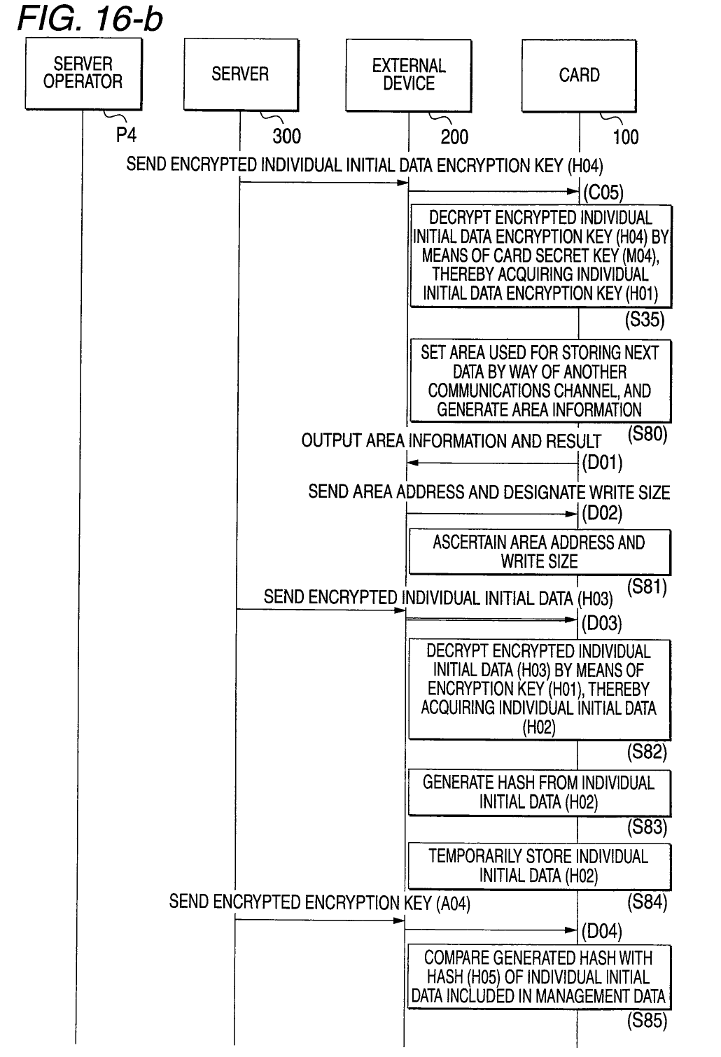

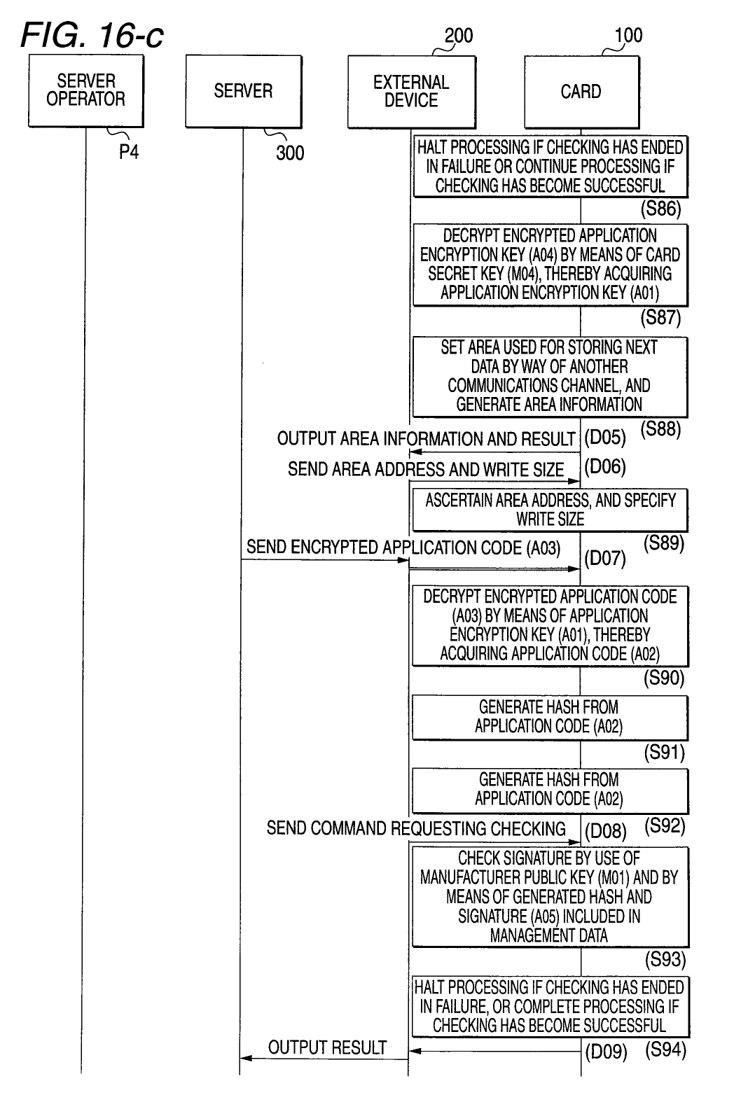

FIG. 13 shows the flow of communication established between the card (100) and the external device (200) when the card has two communications channels. A flow of processing performed by the respective players is described by reference to FIGS. 16-a, 16-b, and 16-c.

First, descriptions are provided by reference to FIG. 16-a. In the card (100), the communications unit (1001) receives the encrypted management data encryption key (H10) from the server (300) by way of the external device (200) (C01), and passes the thus-received key to the command interpretation unit (1002). The command interpretation unit (1002) checks the command imparted to the data, thereby interpreting what is indicated by the command and the purpose of use of the command. In the present embodiment, specifics of the command describe the following operation on the assumption that an application will be installed into the card. The command interpretation unit (1002) notifies the numerical computation unit (1004) that processing is installation of an application, and passes received data to the numerical computation unit (1004). The numerical computation unit (1004) acquires the card RSA secrete key (M04) retained in the storage unit (1005) by way of the storage control unit (1003); and decrypts the received data by means of the encryption/decryption unit (1006), thereby acquiring the management data encryption key (H08) (S31). The numerical computation unit (1004) retains the decrypted management data encryption key (H08) in the storage unit (1005) by way of the storage control unit (1003). When foregoing processing can be performed without involvement of problems, the card (100) outputs to the external device (200) and the server (300) a code signifying normal end (C02).

The communication unit (1001) next receives the encrypted management data (H09) by way of the external device (200) (C03). The numerical computation unit (1004) decrypts through use of the management data encryption key (H08) the management data (H09) encrypted by the encryption/decryption unit (1006), thereby acquiring the management data (H07) (S32). Since the decrypted management data (H07) comply with the previously defined format (FIG. 9), the numerical computation unit (1004) reads data in accordance with the format. The information for identifying an application is used for checking whether or not the application possessing the same identification information is already present in the card (100) (S33). When the same identification information is already present, the numerical computation unit (1004) halts (stops) installation processing. When outputting a result to the external device (200) and the server (300) (C04), the numerical computation unit (1004) outputs the result not as normal end but as an error code showing an overlap of the identification information. When there is no overlap of identification information, the common data are tentatively stored in the storage unit (1005) by way of the storage control unit (1003) (S34). An output of the result is not limited to the error. When anomalous operation is detected, a code to the effect that communication has already been previously exchanged with the outside is output.

Next, descriptions are provided by reference to FIG. 16-b. In the card (100), the communication unit (1001) receives the encrypted individual initial data encryption key (H04) by way of the external device (200) (C05), and passes the thus-received key to the numerical computation unit (1004). The numerical computation unit (1004) decrypts the encrypted individual initial data encryption key by means of the encryption/decryption unit (1006) and by the use of the card RSA secret key (M04) retained in the storage unit (1005), thereby acquiring the individual initial data encryption key (H01) (S35). The decrypted individual initial data encryption key (H01) is retained in the storage unit (1005) in the card. The numerical computation unit (1004) makes a determination to receive the next individual initial data by the use of the high-speed communications channel not by the use of the low-speed communications channel; acquires from the storage control unit (1003) address information used for expanding data; and notifies the address information to the area control unit (1010) (a former part of S80). The numerical computation unit (1004) notifies the decrypted individual initial data encryption key (H01) to the area control unit (1010). The area control unit (1010) retains the received address information; generates an area address, which corresponds to the address information and which is to be opened for the outside, and an area size (a combination of these two pieces of information is hereinafter taken as “area information”) (a latter part of S80); and transmits the area information to the numerical computation unit (1004). The numerical computation unit (1004) outputs the area information to the external device (200) (D01). The area control unit (1010) sets the received individual initial data encryption key (H01) as a decryption key.

By the use of the received area information and by utilization of the high-speed communications channel, the external device (200) transmits a command (hereinafter called an “area information setting command”) used for notifying the card (100) of an area address where data are to be written and an area size (a write size) (D02). It is not matter if the area size will be smaller than the notified size. The communication unit (1001) receives the area information setting command and transmits the data to the command interpretation unit (1002). The command interpretation unit (1002) interprets the area information setting command and notifies the area address and the write size to the area control unit (1010). The area control unit (1010) ascertains the area address and sets the write size (S81). When the address is different or when the size is larger than the previously notified size, an error arises.

The communication unit (1001) next receives the encrypted individual initial data (H03) transmitted by the use of the high-speed communications channel (D03). The communication unit (1001) passes the data to the command interpretation unit (1002). The command interpretation unit (1002) transmits the received data to the area control unit (1010).

The area control unit (1010) decrypts the encrypted individual initial data (H03) by the use of the individual initial data encryption key (H01) and by means of the encryption/decryption unit (1006), thereby acquiring the individual initial data (H03) (S82). The area control unit (1010) tentatively stores the decrypted individual initial data (H02) into the storage unit (1005) (S84). The area control unit (1010) generates the hash of the individual initial data (H02) by means of the hash generation unit (1009) (S83).

Next, the communication unit (1001) receives, by way of the external device (200), data (A04) into which the application encryption key is encrypted (D04); and passes the thus-received data to the numerical computation unit (1004). The numerical computation unit (1004) acquires the hash generated by the area control unit (1010), and checks whether or not the thus-generated hash is identical with the hash (H05) of the individual initial data included in the management data, through use of the checking unit (1007) (S85).

Subsequently, processing proceeds to FIG. 16-c. When the hash generated by the area control unit (1010) is different from the hash (H05) of the individual initial data included in the management data, the numerical computation unit (1004) halts installation processing. On outputting a result to the external device (200) and the server (300) (D05), the card (100) outputs not normal end but an error code to the effect that the hash is different (S86). The numerical computation unit (1004) decrypts the application encryption key (A04), which is encrypted by means of the encryption/decryption unit (1006), by the use of the card RSA secret key (M04) retained in the storage unit (1005), thereby acquiring the application code encryption key (A01) (S87). The numerical computation unit (1004) makes a determination to receive the next application code by the use of the high-speed communications channel not by the use of the low-speed communications channel; acquires from the storage control unit (1003) address information used for expanding the code; and notifies the address information to the area control unit (1010). The numerical computation unit (1004) notifies the decrypted application code encryption key (A01) to the area control unit (1010). The area control unit (1010) retains the received address information; generates an area address, which corresponds to the address information and which is to be opened for the outside, and an area size (a combination of these two pieces of information is hereinafter taken as “area information”); and transmits the area information to the numerical computation unit (1004) (S88). The numerical computation unit (1004) outputs the area information to the external device (200) (D05). The area control unit (1010) sets the received application code encryption key (A01) as a decryption key.

By the use of the received area information and by utilization of the high-speed communications channel, the external device (200) transmits a command (hereinafter called an “area information setting command”) used for notifying the card of an area address where data are to be written and an area size (a write size) (D06). It is not matter if the area size will be smaller than the notified size. The communication unit (1001) receives the area information setting command and transmits the data to the command interpretation unit (1002). The command interpretation unit (1002) interprets the area information setting command and notifies the area address and the write size to the area control unit (1010). The area control unit (1010) ascertains the area address and sets the write size (S89). When the address is different or when the size is larger than the previously notified size, an error arises.

The communication unit (1001) next receives, from the server (300) and by way of the external device (200), the encrypted application code (A03) transmitted by the use of the high-speed communications channel (D07). The communication unit (1001) passes the data to the command interpretation unit (1002). The command interpretation unit (1002) transmits the received data to the area control unit (1010).

The area control unit (1010) decrypts the encrypted individual initial data by the use of the application encryption key (A01) and by means of the encryption/decryption unit (1006), thereby acquiring the application code (A02) (S90). The area control unit (1010) generates hash of the application code (A02) by means of the hash generation unit (1009) (S91). The numerical computation unit (1004) tentatively stores the decrypted application code (A02) into the storage unit (1005) (S92).

Next, the communication unit (1001) receives from the external device (200) a command to request verification (D08), and passes the thus-received command to the numerical computation unit (1004). The numerical computation unit (1004) acquires the hash generated by the area control unit (1010); decrypts the signature (A05) included in the management data by use of the manufacturer public key (M01) and by means of the encryption/decryption unit (1006), to thus acquire hash; and checks the thus-acquired hash against the hash of the acquired application code through use of the checking unit (1007) (S93). When a difference exists between the hashes, the numerical computation unit (1004) halts installation processing. On outputting a result to the external device (200) and the server (300) (D09), the numerical computation unit (1004) outputs not normal end but an error code to the effect that the hashes are different from each other. When the hashes are identical with each other, the numerical computation unit (1004) notifies the determination unit (1008) that the signature is normal, and completes installation processing (S94). Upon receipt of the notification that the signature is valid, the determination unit (1008) determines the hash of the individual initial data encrypted along with the signature and common data to be valid, and makes the common data, the individual initial data, and the application code relevant to the application operable in the card. The numerical computation unit (1004) outputs to the external device (200) and the server (300) the code to the effect that processing has ended normally (D09).

In the present invention, through use of area information (D01 and D05) imparted to the output data from the card (100), the external device (200) can acquire timing at which the high-speed communications channel is used, an area that is a target of writing, and the size of the target area. The external device (200) subsequently transmits the received area information to the card (100), thereby notifying the card (100) of information about the area where data are to be written by use of the high-speed communications channel and the size of the area (D02 and D06). Next, data (individual initial data and an application code) are written into the card (100) by use of the high-speed communications channel (D03 and D07).

Use of the present invention enables, by means of single operation, notification of information which cannot be acquired by means of the external device (200) merely receiving encrypted data from the server (300); namely, information about whether or not the card (100) has a plurality of communications channels; information about timing at which there is performed switching between the low-speed communications channel and the high-speed communications channel; and information about where data are to be written.

The external device (200) can determine the number of communications channel from the identification information about the card (100). So long as the external device (200) is provided with information about the type of encrypted data transmitted to the card (100) in advance, timing can be switched. However, it is impossible for the external device to acquire information about the area where data are to be written unless the external device acquires information from the card (100). For this reason, performing switching operation at the time of acquisition of area information obviates a necessity for attempting another determination method, whereupon improved efficiency is attained.

In connection with a method by means of which the application developer (P2) files an application for a signature with the card manufacturer (P1), a method for physically, visually, and socially ascertaining the application developer (P2) is not stipulated in the system. A personal identification method implemented by public institutions, financial institutions, and the like may also be utilized. Likewise, in relation to a system for delivering a generated signature and a system for delivering a development environment distributed from the card manufacturer (P1) to the application developer (P2), a common distribution method is adopted, and no further mention is made. Moreover, it is also possible to file an application for a signature by use of the development environment, to thus establish an encryption session between the development environment of the application developer and the manufacturer and distribute a signature. However, establishment of the encryption session cannot be realized unless the development environment can be distributed correctly, safely.

In the present embodiment, the players are categorized into three parties; namely, an application developer, a service provider, and a server operator. However, the nature of processing of the three parties is not limited to construction of data to be commonly used, construction of data to be individually used, and distribution of data. The final point of reliability is placed on the signature of the application imparted by the manufacturer, and the objective of the present invention is to install the application by trusting the application including data related thereto. The present invention is not affected at all by changes in the nature of processing performed by the three parties.

Although, in the present embodiment, the common card RSA secret key (M04) is set in all of the cards, the present invention is not limited to the embodiment. It does not matter if the individual card RSA secret key (M04) will be set in all of the cards. In that case, a public key certificate corresponding to the card RSA secret key (M04) is held in the card, and the public key certificate is sent to the server. After verifying the validity of the certificate, the server can encrypt the data (the individual initial data and an application code) by utilization of the public key included in the certificate. Hence, the data can be sent on a card-by-card basis.

In the present embodiment, the public key (M01) of the card manufacturer (P1) is set in cards. However, the embodiment is not limited to the embodiment. Any business person or organization can perform signature processing as a proxy, so long as the card manufacturer has empowered the person or organization to perform signature processing. In this case, the card manufacturer issues a certificate by use of a secret key of the card manufacturer for the public key pair of the business person or organization that is to be empowered. The thus-empowered business person or organization affixes, through use of its secret key, a signature to an application code. The empowered business person or organization sends to the card the certificate issued by the manufacturer. The card is subjected to verification of a certificate by use of the public key (M01) of the card manufacturer stored in the card. When the certificate can be determined to be valid, the public key included in the certificate is used as a signature verification key of the application. When the encryption data including the signature generated by the empowered business person or corporation are sent to the card, the card uses the signature verification key, and hence the validity of the signature generated by the empowered business person or organization can be ascertained.

The method for generating hash described in connection with the present embodiment uses a one-way function, and SHA-1, MD5, SHA-256, or the like, is used in the related art. The purpose of use of the one-way function is to summarize large-scale data and perform distinction by means of a small volume of data. If the data are already in small size and if there is no necessity for generating hash, the value of the data may also be subjected, in its present form, to comparison.

The signature described in connection with the embodiment is not described exclusively for the case of the public key encryption scheme. When the encryption algorithm to be utilized is a common key encryption scheme, a signature corresponds to a message authentication code (MAC). In connection with a method for generating a signature, a signature is affixed by means of a secret key after preparation of hash in the present embodiment. As already described in connection with the method for generating hash, so long as the data is already in small size, the data may also be utilized in its present form.

In the present embodiment, HTTP or HTTPS is described in connection with the communications channel between the server and the external device. However, the present invention is not limited to these channels. So long as a communications channel is generally a technique for establishing communication between the server and the external device, the channel does not affect the present invention at all without regard to whether the technique is wired or wireless. Therefore, the server and the external device can also establish original encryption communication. The behavior of the card is not changed by encryption communication.

The system provided in the embodiment is an example of the secure memory card system of the present invention; the card used in the system corresponds to the secure memory card; and the external device corresponds to the access device. Moreover, the storage unit included in the card corresponds to nonvolatile memory, and a device implementing the other unit corresponds to the memory controller of the present invention.

Although the present invention has been described in detail and by reference to the specific embodiment, it is manifest to those who are versed in the art that the present invention is liable to various alterations or modifications without departing from the spirit and scope of the present invention.

The present patent application is based on Japanese patent application (JP-A-2006-218795) filed on Aug. 10, 2006 in Japan, the contents of which are hereby incorporated by reference.

### INDUSTRIAL APPLICABILITY

The secure memory card of the present invention can be utilized as a secure memory card that receives and stores data.

1. A secure memory card comprising:
a communication unit receiving at least encryption data and data to be signed;
an encryption/decryption unit subjecting arbitrary data to encryption/decryption processing;
a checking unit checking the data to be signed against a signature stored in the encryption data decrypted by the encryption/decryption unit;
a determination unit determining validity of the data to be signed on the basis of a checking result of the checking unit; and
a storage unit for storing, as valid data, data other than the signature of the encryption data including the signature when the determination unit determines that the data to be signed are valid.

2. The secure memory card according to claim 1, wherein the communication unit receives first encryption data and second encryption data;
the checking unit checks a signature serving as first data included in the first encryption data decrypted by the encryption/decryption unit against the data decrypted by the second encryption data;
the determination unit determines validity of the second decryption data on the basis of a check result of the checking unit; and
the storage unit stores, as valid data, second data included in the first encryption data when the determination unit determines the second encryption data to be valid.

3. The secure memory card according to claim 2, wherein the communication unit receives third encryption data;
third data included in the first encryption data are hash of the third encryption data; and
the determination unit verifies validity of the third encryption data by use of the hash.

4. The secure memory card according to claim 3, wherein a plurality of sets of third data included in the first encryption data are hashes of a plurality of sets of third encryption data, and the determination unit determines validity of the plurality of respective third encryption data by use of the respective hashes of the plurality of sets of third data.

5. The secure memory card according to claim 2, wherein link information showing a destination to which a reference is to be made is included in the first encryption data.

6. The secure memory card according to claim 2, wherein the storage unit stores first encryption key information set in either when a manufacturer of the secure memory card manufactures the secure memory card or when the secure memory card is issued.

7. The secure memory card according to claim 3, wherein the communication unit receives fourth encryption data; and
the encryption/decryption unit decrypts the fourth encryption data by use of the first encryption key information and decrypts the first encryption data, the second encryption data, and the third encryption data by using the decrypted fourth encryption data as a second encryption key.

8. The secure memory card according to claim 7, further comprising:
a decryption key management unit managing the second encryption key and storage data including the decrypted first encryption data, the decrypted second encryption data, and the decrypted third encryption data.

9. The secure memory card according to claim 8, wherein, after the storage data are decrypted by the first encryption key at the time of updating of the storage data, the storage data are decrypted by the second encryption key.

10. The secure memory card according to claim 3, further comprising:
an area control unit transmitting, to an external device, area information showing an area of the storage unit where at least either the second encryption data or the third encryption data are stored, wherein the area information is transmitted to the external device.

11. The secure memory card according to claim 6, wherein the signature is prepared by the manufacturer.

12. The secure memory card according to claim 3, wherein the first encryption data are for managing an application which is executable in the card;
the second encryption data are the executable application code itself; and
the third encryption data are to be used by the application.

13. A memory controller comprising:
a communication unit receiving at least encryption data and data to be signed;
an encryption/decryption unit subjecting arbitrary data to encryption/decryption processing;
a checking unit checking the data to be signed against a signature stored in the encryption data decrypted by the encryption/decryption unit;
a determination unit determining validity of the data to be signed on the basis of a checking result of the checking unit; and
a storage unit storing, as valid data, data other than the signature of the encryption data including the signature when the determination unit determines that the data to be signed are valid.

14. The memory controller according to claim 13, wherein the communication unit receives first encryption data and second encryption data;
the checking unit checks a signature serving as first data included in the first encryption data against data obtained by decryption of the second encryption data; and
second data included in the first encryption data are stored as valid data in the storage unit when the checking unit determines the decrypted second encryption data to be valid.

15. The memory controller according to claim 14, wherein the communication unit receives third encryption data;
third data included in the first encryption data are hash of the third encryption data; and
the determination unit verifies validity of the third encryption data by use of the hash.

16. The memory controller according to claim 15, wherein the first encryption data are for managing an application that is executable in the card;
the second encryption data are the executable application code itself; and
the third encryption data are to be used by the application.

17. A secure memory card system having an access device and a secure memory card that performs reading or writing of data in accordance with an access instruction from the access device, the card comprising:
a memory controller including
a nonvolatile memory;
a communication unit receiving at least encryption data and data to be signed;
an encryption/decryption unit subjecting arbitrary data to encryption/decryption processing;
a checking unit checking the data to be signed against a signature stored in the encryption data decrypted by the encryption/decryption unit;
a determination unit determining validity of the data to be signed on the basis of a checking result of the checking unit; and
a storage unit storing, as valid data, data other than the signature of the encryption data including the signature when the determination unit determines that the data to be signed are valid, wherein
a result computed by the determination unit is notified to the access device by use of the communication unit.

18. An access device that is connected to a secure memory card having nonvolatile memory, to thus be used, the device comprising:
a communication unit establishing communication with the secure memory card;
a storage unit storing data to be transmitted to the secure memory card; and
a protocol conversion unit that reads from the storage unit data to be transmitted to the secure memory card and that converts the data into data which can be received by the secure memory card, wherein
a result notified by the secure memory card is received, and communication with the secure memory card is controlled on the basis of the result.
